(19) United States
(12) Patent Application Publication
(10) Pub. No.: US 2014/0319800 A1
(43) Pub. Date: Oct. 30, 2014

(54) LONGITUDINAL BICYCLE FOLDING SYSTEM

(71) Applicant: Rafael Marin Garrido, Santander (ES)

(72) Inventor: Rafael Marin Garrido, Santander (ES)

(21) Appl. No.: 14/114,292

(22) PCT Filed: Apr. 27, 2012
(86) PCT No.: PCT/ES2012/000127

§ 371 Date: Mar. 12, 2014

(30) Foreign Application Priority Data
Apr. 27, 2011 (ES) P201100486

(51) Int. Cl. B62K 15/00

(52) U.S. Cl. CPC B62K 15/006; B62K 2015/003
USPC 280/287

(57) ABSTRACT

The invention relates to a longitudinal folding system for bicycles that comprise at least: handlebars including a locking element, a partition and a release button; a saddle pillar with a reinforcement and a female connector; a foot rest; a main bar; an anchor; a central bar which can pivot in relation to the main bar and is arched with a C-shaped cross-section; and a fork that can include foldable pedals. In addition, the invention comprises a chain wheel, an integral shifter, a drive belt, a luggage rack, saddle-bags/bag and, optionally, an i-phone holder and decorative elements. The system is characterised in that the longitudinal plane of the main bar is parallel to that defined by the rear wheel, but shifted slightly in relation thereto in order to prevent interference between the main bar and the rear wheel during folding. The bar, the handlebars and the fork pivot about an axis until the fork is positioned next to the wheel. The luggage rack, which includes an opening, can be moved closer to the wheel.

### TECHNICAL OBJECT OF THE INVENTION

The object of the present invention refers to a system for bicycle folding designed specifically for the folding process to occur in its principal plane, that is, the longitudinal plane of the bicycle. As a prior step, it is necessary to remove the front wheel and undo the rigid structure of the frame by disconnecting the rear end of what is designated in this document as the central bar, then proceeding with the folding process with the added advantage that all the components of the bicycle can be placed in the saddle-bags, which are included as an accessory, it being possible to transport the whole like a suitcase of medium weight, since it is not more than fifteen kilograms. The system is applicable to any type of bicycle, as long as it is constructed in the manner described in the present document. However, to facilitate the understanding of the specification, the inventor applies this new folding system to a prototype bicycle which, besides pursuing the objective of accomplishing a folding bicycle according to an innovative idea, turns out to be different from the ones known thus far, having very attractive lines with a very polished finish.

### TECHNICAL FIELD OF THE INVENTION

The present invention belongs to the Sector of Consumer Products, chapter Health, Protection, Entertainment, as regards Sports, Games and Amusements, from an industrial standpoint pertaining to the fabrication of light, folding-type bicycles.

### ANTECEDENTS OF THE INVENTION

The bicycle is a means of transportation that is very widespread in the modern world.

The automobile at one time displaced this type of vehicle for obvious reasons of improved quality of life, but it is certain that the bicycle has always been present in households with any purchasing power.

At present, economic hardships have led to a resurgence of the bicycle for use as a means of transportation, although in any case its use is still customary as an athletic exercise, or for simple entertainment.

In the field of folding bicycles, there are increasingly many antecedents with new ideas that claim to reconcile the intrinsic advantages of the bicycle with the possibility of storing it in little space or transporting it optionally in alternative means of transportation, such as buses, taxi cabs, subways, or railroads in general.

It is difficult to optimize all the parameters of a bicycle to achieve the ideal folding vehicle and therefore in some instances preference is given to the overall weight, in others to the dimensions, in others to the size of the wheels, etc.

Each of the models existing on the market has its advantages and drawbacks, so that the buyer of a folding bicycle chooses it according to the intended use. If it has to be folded and unfolded several times a day, there are models adequate to this purpose with very small wheels and pantograph type folding, but if all that is needed is to transport it in the trunk of a car for use on a vacation one will choose types with larger wheels and free type folding.

One could cite a series of methods that reveal the breadth of distinct solutions found on the market today, but none of them conforms to the system of folding which the inventor presents in this document, corresponding to a bicycle whose wheel is 26 inches, that is, the usual size of mountain bikes, with the particularity that it folds onto itself by following movements in its principal longitudinal plane. The folding process does not require special tools, so that it is within the reach of any person with a minimum of skill. Furthermore, as mentioned before, it is possible to place the whole in the bicycle saddle-bags so that it can be handled as though it were a suitcase.

### DESCRIPTION OF THE INVENTION

The present invention, as mentioned above, refers to a new folding system applicable to any type of bicycle, as long as it is constructed according to the general characteristics indicated in this document, which as an example and to facilitate its understanding centers on a bicycle with a large wheel (the size of mountain bikes). It involves a very innovative method, the result of the folding being a whole that can be placed in the saddle-bags of the bicycle itself for transport.

The folding process begins by first removing the front wheel and unlocking the rear part of the upper frame bar, which shall be termed the central bar, and which pivots on another bar, termed in this document the main bar.

In this way, the structure of the bicycle is divided into two groups. The first, formed by the front fork, handlebars, central bar and main bar, and the second, formed by everything else.

Now, in the aforesaid condition, it is possible to rotate the first group relative to the second group about a physical axis which is slightly displaced relative to the pedal axis and at greater height than the latter, in the hypothesis shown by the drawings of the present document. In another embodiment, likewise feasible, the physical axis can be below the pedal axis, but this is not relevant.

It is then possible to perform the folding manually, so that as we shall see the rear wheel moves without interference parallel to the main bar which, as we have seen, is what joins the front fork to the pedal axis.

In the model being used for the specification, the main bar is composed of two parallel and mirror symmetrical parts with a very characteristic shape. The front wheel fork remains partially covering the rear wheel.

As a supplemental folding operation, in cases where the bicycle is outfitted with a luggage rack, it is necessary to disengage the pins from the nuts of the rear wheel by pulling slightly outward to allow a certain rotation of said rack toward the wheel in which it is lightly inserted, thanks to the wide opening existing in the support plane of the cargo.

Lastly, one proceeds to fold the pedals onto their corresponding rods, then applying certain rotations to the handlebars which, as we shall see, is also of a special design, by which one achieves a final folding situation in which the bicycle set takes on a shape that resembles a prism with an essentially square base and height equal to the widest dimension of the bicycle in use, that is, the final dimensions are on the order of 75×75×30 cm. This volume and a total weight close to 16 kilos (which can vary depending on the materials of which it is made) make it possible to carry the bicycle, once folded, easily in the street, in any public transportation, or in the trunk of a car.

This is a bicycle which the inventor proposes to manufacture in limited and personalized series, furthermore incorporating decorative patterns of special design in places, produced with a hot punch. The frame and luggage rack are constructed of hard-wearing material or composite such as marine plywood, even though this does not imply that traditional light materials such as aluminum or steel can be used. It has also been considered to incorporate a box where an iphone can be placed and transported in total security.

The folding operation does not require special tools, since all the elements that need to be loosened or removed come with easily operated quick closure mechanisms.

### DESCRIPTION OF THE DRAWINGS

Eight figures are included with the following meaning:

FIG. 1 shows schematically the assembled bicycle, seen from the left side, indicating the following elements:
1. Bicycle
2. Front wheel
3. Rear wheel
4. Front fork
5. Rear fork
5.1. Footrest
5.2. Footrest unfolded
6. Main bar
6.1. Anchor stop
7. Central bar
7.1 Articulated fork
8. Seat bar
8.1. Reinforcement
8.2. Female connector
9. Handlebars
9.1. Locking element
9.2. Partition
9.3. Release button
10. Seat
11. Luggage rack
12. Pedal axis
13. Folding axis
14. Chain wheel
15. Integral shifter
16. Drive belt
17. Decorative patterns

FIG. 2 shows the same bicycle as seen from the right side.

FIG. 3 In this figure one sees the bicycle in its folded state, after removing the front wheel and disconnecting the central bar. The seat, handlebars and pedals are shown by dotted line to indicate that their position has been modified to minimize the occupied volume. The same elements as in the previous figures are indicated.

FIG. 4 The main bar is shown in three orthogonal views of plan, elevation and cross section. The following is indicated:
6.2. Iphone holder

FIG. 5 The central bar is shown in three orthogonal views of plan, elevation and cross section. Its cross section is in the shape of a crescent, having a pivot axis in the front part and a small fork articulated in the rear part to allow its placement closing the frame structure of the bicycle. The following is indicated:
7.1. Articulated fork
7.2. Pivot axis

FIG. 6 The luggage rack is shown in three orthogonal views of plan, elevation and cross section. One can see the opening which allows for the partial inserting of the rear wheel in the folded position.
11.1. Opening

FIG. 7 The handlebars are shown in plan and cross section views in their working position (solid line) and folded position (broken line).

FIG. 8 The saddle-bags are shown in the form of a pouch designed to protect the bicycle for the periods of storage or transport.
18. Saddle-bags/pouch

### DESCRIPTION OF A PREFERRED EMBODIMENT

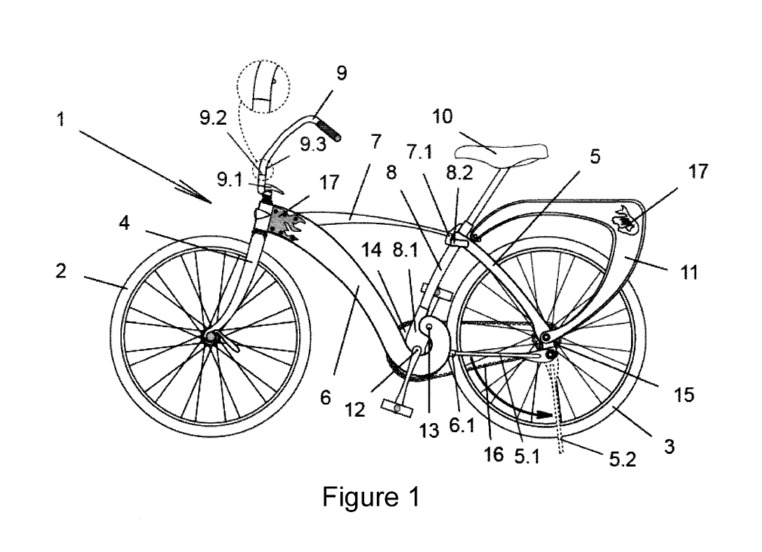

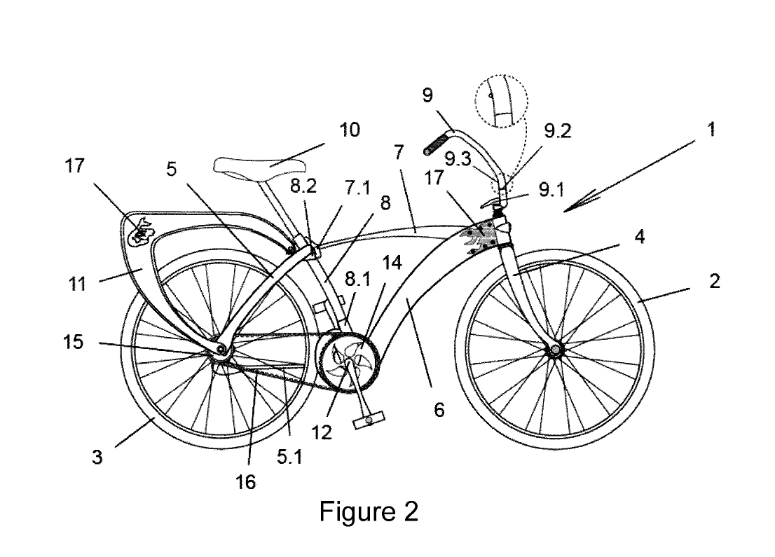

In a preferred embodiment, the longitudinal folding system for bicycles (1) (FIGS. 1 to 8) refers to a form of folding of any type of bicycle that has been constructed according to a special design that is reflected in this document, using as an example that of a bicycle with large wheel, specifically a 26 inch tire, which is customary for mountain bikes.

The system of the invention makes it possible to fold the bicycle along its longitudinal plane by performing a series of simple operations not requiring special tools, after which it can be placed in its own saddle-bags, being converted into a transport pouch.

The system applies, in this specific case, to a bicycle composed of a front wheel (2) and a rear wheel (3) with 26-inch tires, the former being mounted on the front fork (4), which forms a single piece with the handlebars (9) to constitute the steering system. It is important to note that the handlebars (9) (FIG. 7) can turn about a horizontal axis by simply loosening the locking element (9.1), but in addition it has a partition (9.2) in each of its two arms and release buttons (9.3) for each of them, enabling a turning of the arms relative to the part fixed to the stem of the handlebars (9) by the locking element (9.1).

The rear wheel (3) is mounted on the rear fork (5), which is rigidly joined to the seat bar (8), which receives the stem of the seat (10) by its upper part and incorporates the reinforcement (8.1) by its lower part.

The frame structure in order to make possible the longitudinal folding system is supplemented with another two bars which shall be called the main bar (6) and the central bar (7), whose characteristics shall be explained below, there being as well another bar, called the footrest (5.1), which connects the axis of the rear wheel to the main bar (6), forming a triangle with the rear fork (5) and the seat bar (8). This footrest (5.1) is articulated near the rear axle and engages by a slight pressure in the anchor stop (6.1), joined by welding to the main bar (6). When one wishes to part the bicycle (1), the footrest (5.1) is extracted from the anchor stop (6.1) and placed in the position of the unfolded footrest (5.2), as shown by the broken line in FIG. 1. That is, the footrest (5.1) has, on the one hand, a clearly structural function to close the rear triangle and, on the other hand, the function of a “foot piece” for typical parking of motorcycles and some bikes. In certain models, without affecting the folding system as described in this document, one opt for a duplicate footrest (5.1), whose counterpart is placed symmetrically on the other side of the rear wheel (3). Although this might imply a slight increase in the total weight, it results in a greater rigidity of the rear triangle, ensuring an engaging of the drive belt (16) with the chain wheel (14) and the integral shifter (15) when the forces applied to the pedals are of extreme magnitude.

The integral shifter (15) with multiple speeds is integrated in the rear bushing and the drive belt (16), toothed and made of neoprene, enables a soft and silent ride.

In any case, the proposed system can be applied to any other type of shifting and transmission, even though the inventor considers the solution presented in this document to be preferred.

In addition, the bicycle (1) has pedals of the kind known as foldable, that is, they fold down on their corresponding connecting rods, and optionally a luggage rack (11) with saddlebags/pouch (18) which can be transformed, designed to carry small items of the rider and keep the bicycle in its periods of inactivity or transport in automobiles or other means of transportation.

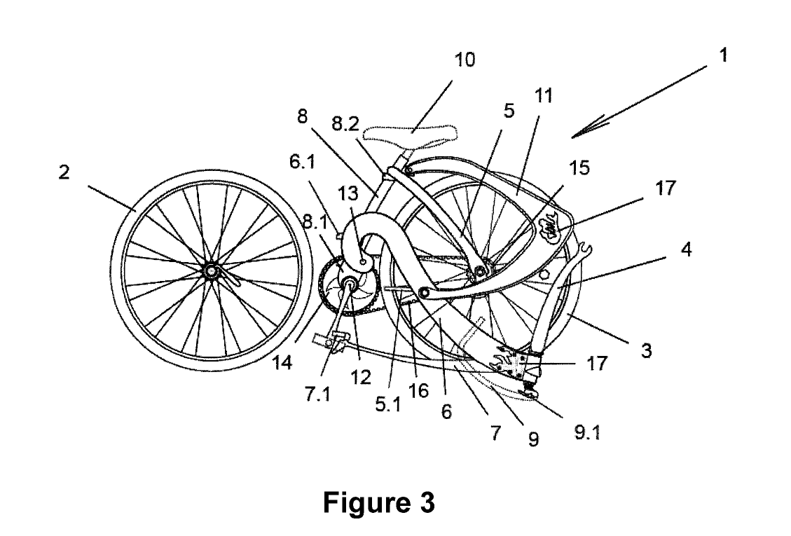

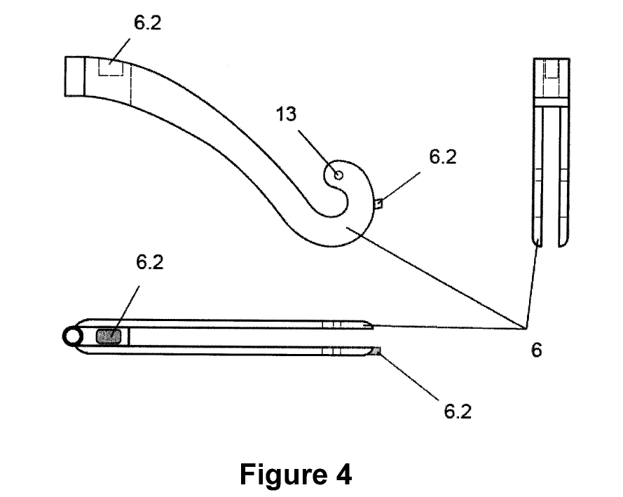

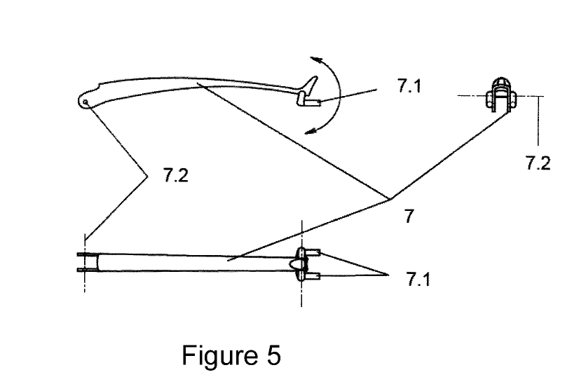

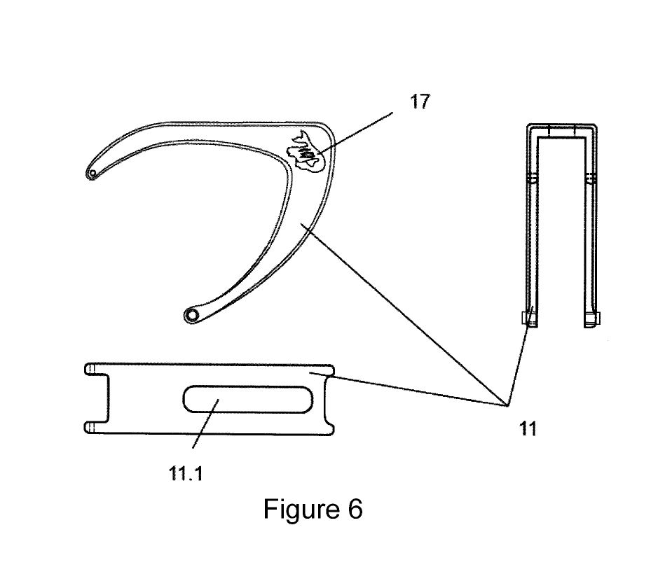

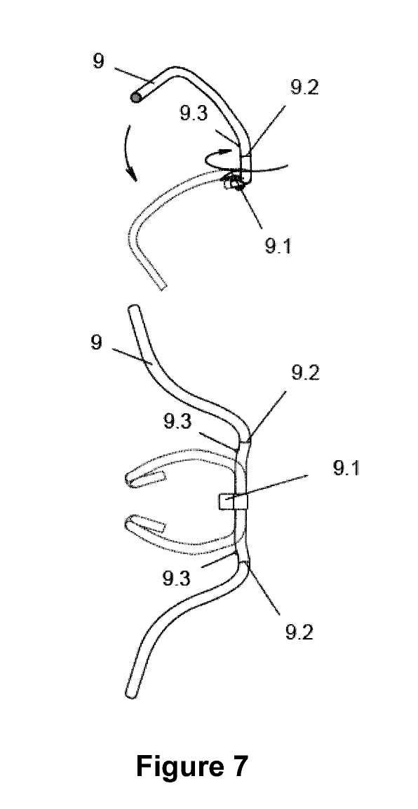

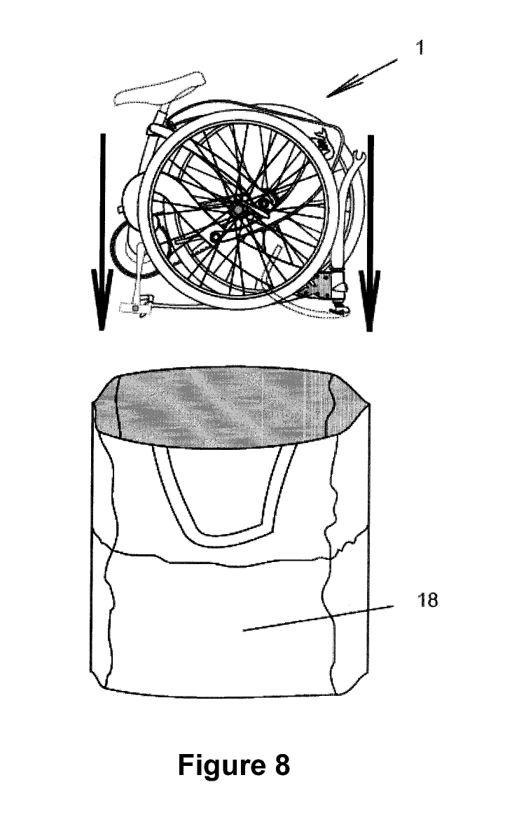

As for the main bar (6), which is what joins the front fork (4) to the pedal axis (12), this has the peculiarity of being situated in a plane different from the one defined by the front wheel (2) (with the handlebars in straight line). This means there will be no mutual interference in the longitudinal folding process. It will be understood that, for reasons of equilibrium and symmetry, the inventor prefers to double the main bar (6) so that its two parallel and mirror-symmetrical branches for a longitudinal opening or window through which the rear wheel (3) can pass (FIGS. 3 and 4).

The central bar (7) (FIG. 5) also has a special design which allows it to turn on the front pivot axis (7.2) when its rear part is released, being equipped with an articulated fork (7.1) that is inserted on the female connector (8.2), double joined to the seat bar (8).

The longitudinal folding system for bicycles is characterized in that, once the front wheel (2) has been removed and the central bar (7) disconnected, it is possible to produce a movement of rotation of the main bar (6) on a horizontal transverse axis, designated as the folding axis (13), situated at the reinforcement (8.1) in a position slightly higher than the pedal axis (12). The outcome of the folding is shown in FIG. 3, where one notices that the main bar (6) and the front fork (4) have remained in a state of coupling to or superpositioning on the rear wheel (3). As for the coupling of the front fork (4) to the rear wheel (3), it is easily understood, since it is arranged in a very similar way to the coupling to the front wheel (2). This system of folding is possible thanks to the design and placement of the main bar (6) which, as stated in previous paragraphs, is situated in space in a plane parallel to the one formed by the wheels of the bicycle when the front wheel (2) is oriented in a straight line. In this way, interference is prevented between the main bar and the rear wheel (3) during the folding process. The inventor believes that the finish and the balance of the bicycle is improved by a “split” or doubling of the main bar (6), which is configured in the bicycle (1) of the example as a long fork that has two feet extending from the folding axis (13), in the reinforcement (8.1), as far as the axis of the handlebars (9) and form a longitudinal window through which the rear wheel (3) is introduced. The hook-shaped curvature of the main bar (6) with turning on the folding axis (13), embodied in the reinforcement (8.1), follows a design in a preferred embodiment of the invention that is presented in this document.

Even so, this does not rule out another embodiment, likewise preferred, in which the rear fork (5) is the one that is articulated to the seat bar (8) and introduced, during the folding process, into the opening of the main bar (6), in which case it would not be necessary to disconnect the central bar (7). This would keep unchanged the classic triangle of nearly all bicycles, formed by bars homologous to the main bar (6), the central bar (7) and the seat bar (8).

When the bicycle (1) has a luggage rack (11) (FIG. 6), the inventor likewise imagines its folding (FIG. 3) by being brought closer to and partially inserted onto the rear wheel (3).

For this, it is necessary to slightly force outward the pins of the rack (11), extracting them from their fitting at the nuts of the rear axle, and then produce the motion of coming closer to the rear wheel (3) and then being partially inserted on same, thanks to the opening (11.1) shown schematically in FIG. 6.

The folding system is finished by gathering up as much as possible the other elements of the bicycle (1), such as the seat (10) and the handlebars (9).

As for the seat (10), it is sufficient to lower it as much as possible, after loosening its rapid closure.

In regard to the handlebars (9), one loosens the locking element (9.1) to rotate the entire handlebars (9) downward and then pressing both release buttons (9.3) so that the ends of the handlebars rotate on their corresponding partitions (9.2), coming close to the body of the bicycle (1) until a minimum footprint is achieved.

There is nothing in particular to be said for the pedals since, being of folding type, it is sufficient to fold them down on their connecting rods.

The saddlebags/pouch (18) are configured so that, when mounted on the luggage rack (11), they serve to carry small articles of the rider, but are also able to adopt the shape of a large pouch whose dimensions are able to accommodate all the components of the bicycle, once folded, except for the front wheel and the iphone, which is a fragile item that should be kept in a purse, a wallet, or the like.

The basic elements of the bicycle (1) in the example, such as the main bar (6) and the luggage rack (11), are made of hard-wearing materials, it being recommended by the inventor to fabricate them of marine plywood, well polished to give the whole a select and elegant look, supplemented with decorative patterns (17) that can be placed on the main bar (6) and on the luggage rack (11), as shown in the drawings of this document, where there is also provided an iphone holder (6.2) (FIG. 4). It is also possible to add other features in different places to improve the finish of the bicycle which, thanks to the integral shifter (15) and the drive belt, behaves like a comfortable, clean and silent vehicle.

It is not deemed necessary to extend this specification in order for a person skilled in the art to be able to understand its scope and the advantages derived from the invention, as well as develop and put into practice the object of the invention. Even so, it should be understood that the invention has been described in a preferred embodiment, so that it is susceptible of modifications without this entailing or suggesting any change in the basis of this invention. That is, the terms used in this preferred specification of the invention shall always be taken with a broad and nonlimiting understanding.

1. A longitudinal folding system for bicycles, applicable to types of bicycles especially designed with front wheel and rear wheel, secured in the corresponding front fork and rear fork, having a seat and brake elements of the customary kind, characterized in that it applies to bicycles that need to have at minimum a handlebars with locking element, partition, and release button, a seat bar with reinforcement and female connector a footrest that is articulated, a main bar, an anchor stop, a central bar pivoting on the main bar, being arched with a C-shaped cross section and an articulated fork, also needing to have foldable pedals; in addition, it will have a chain wheel, an integral shifter, neoprene drive belt, luggage rack, saddlebags/pouch and other elements, such as an iphone holder and decorative patterns.

2. The longitudinal folding system for bicycles according to claim 1, further characterized in that the longitudinal plane containing the main bar is slightly displaced relative to the plane defined by the rear wheel, so that said main bar does not interfere with the rear wheel in the relative movements called for during the folding process.

3. The longitudinal folding system for bicycles according to claim 1, further characterized in that, once the front wheel has been removed and the articulated fork extracted from the central bar of the female connector, which is joined to the seat bar, the main bar with the handlebars and front fork are able to pivot on the folding axis, situated at the reinforcement, until the front fork is superimposed on the rear wheel.

4. The longitudinal folding system for bicycles according to claim 1, further characterized in that the luggage rack, if present, can be partly inserted in the rear wheel thanks to the existence of the opening.

5. The longitudinal folding system for bicycles according to claim 1, further characterized in that the folded bicycle is capable of being placed in its saddlebags/pouch.
